(19) United States
(12) Patent Application Publication
(10) Pub. No.: US 2020/0287812 A1
(43) Pub. Date: Sep. 10, 2020

(54) NETWORK ANALYZER

(71) Applicants: Ofer Tenenbaum, Napa, CA (US); John Jay Armstrong, Mission Viejo, CA (US); Pavel Vladimirovich Popov, Chita (RU)

(72) Inventors: Ofer Tenenbaum, Napa, CA (US); John Jay Armstrong, Mission Viejo, CA (US); Pavel Vladimirovich Popov, Chita (RU)

(21) Appl. No.: 16/263,151

(22) Filed: Jan. 31, 2019

(51) Int. Cl. H04L 12/26; H04L 12/24; H04L 12/911

(52) U.S. Cl. CPC H04L 43/0811; H04L 43/0876; H04L 47/781; H04L 41/0816; H04L 41/0886; H04L 41/22

(57) ABSTRACT

A non-transient computer readable medium having program code stored thereon for causing a processing device to perform the method comprising accessing information related to local area network traffic, by the processing device and receiving the information, is described. The method also includes displaying a graphical user interface (GUI) for a user of the network and calculating a percentage of impact for each device connected to the network that is using resources on the network. Further, the method includes displaying by the GUI, geometric shapes whose areas on the GUI approximate the relative impact that each device or group of devices has on the network.

### BACKGROUND

Many homes and businesses today have a Wi-Fi or other type of wireless or wired network to which multiple electronic devices connect. Some of these devices connect and disconnect sporadically during use and disuse. Other of these devices, such as appliances and monitors may continuously be connected to and using the network. With so many devices connected to the network on a regular basis, some networks, which do not have large amounts of bandwidth for handling all of the network traffic, may get bogged down, seem to operate sluggishly, or even seem to cease operating at any sort of normal level. These negative impacts on the network performance may result in erroneous and misplaced customer service calls to the Internet Service Provider (ISP) whose service has not been downgraded. Each such call costs the ISP, and many such calls result in large dollar amounts being lost to calls which otherwise may be avoided. Therefore, what is needed is a way to visualize impacts on a network's performance that is easy to use particularly for those who may be less comfortable with solving technical problems.

### SUMMARY

An exemplary embodiment relates to a non-transient computer readable medium having program code stored thereon for causing a processing device to perform the method comprising accessing information related to local area network traffic, by the processing device and receiving the information. The method also includes displaying a graphical user interface (GUI) for a user of the network and calculating a percentage of impact for each device connected to the network that is using resources on the network. Further, the method includes displaying by the GUI, geometric shapes whose areas on the GUI approximate the relative impact that each device or group of devices has on the network.

Another exemplary embodiment relates to a Wi-Fi network. The Wi-Fi network includes a wireless router and a plurality of devices wirelessly communicating with the wireless router. At least one of the plurality of devices is running a network analyzer or the network analyzer running on a cloud server. The network analyzer comprises program code for carrying out the steps of: accessing information related to local area network traffic from the router, by the network analyzer; receiving the information by the network analyzer; displaying a graphical user interface (GUI) on the at least one of the plurality of devices; calculating a percentage of impact for each device connected to the Wi-Fi network that is using resources on the Wi-Fi network; and displaying by the GUI, geometric shapes whose areas on the GUI approximate the relative impact that each device or group of devices has on the Wi-Fi network.

Yet another exemplary embodiment relates to a communications network. The communications network includes a router and a plurality of devices wirelessly communicating with the router. At least one of the plurality of devices is running a network analyzer or the network analyzer running on a cloud server. The network analyzer includes a means for accessing information related to local area network traffic from the router, by the network analyzer and a means for receiving the information by the network analyzer. The network analyzer also includes a means for displaying a graphical user interface (GUI) on the at least one of the plurality of devices; a means for calculating a percentage of impact for each device connected to the communications network that is using resources on the communications network and a means for displaying by the GUI, geometric shapes whose areas on the GUI approximate the relative impact that each device or group of devices has on the communications network.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is an exemplary embodiment of a graphical user interface for a network analyzer.

FIG. 2 is an exemplary embodiment of an alternate screen for a graphical user interface for the network analyzer of FIG. 1.

FIG. 3 is an exemplary embodiment of an alternate screen for a graphical user interface for the network analyzer of FIG. 1.

FIG. 4 is an exemplary embodiment of an alternate screen for a graphical user interface for the network analyzer of FIG. 1.

FIG. 5 is an exemplary embodiment of an alternate screen for a graphical user interface for the network analyzer of FIG. 1.

The use of the same symbols in different drawings typically indicates similar or identical items unless context dictates otherwise.

### DETAILED DESCRIPTION

All devices connected to a local area network, such as but not limited to a Wi-Fi network, a hardwired network or any other type of wireless network, use some amount of bandwidth on the network, however some devices require much more than others and this demand on use of the network changes dynamically at all times throughout the day. For instance, a mobile device such as a tablet on a Wi-Fi that is streaming HD video has much higher demands than a computer with its user reading email. Accordingly, a network impact visualizer can be used to graphically and dynamically display to a user of the network what devices are using the network. Conventional network impact visualizers are seen as displaying information in a way which makes usability and readability difficult while simultaneously having poor functionality. The network impact visualizer described herein solves these deficiencies.

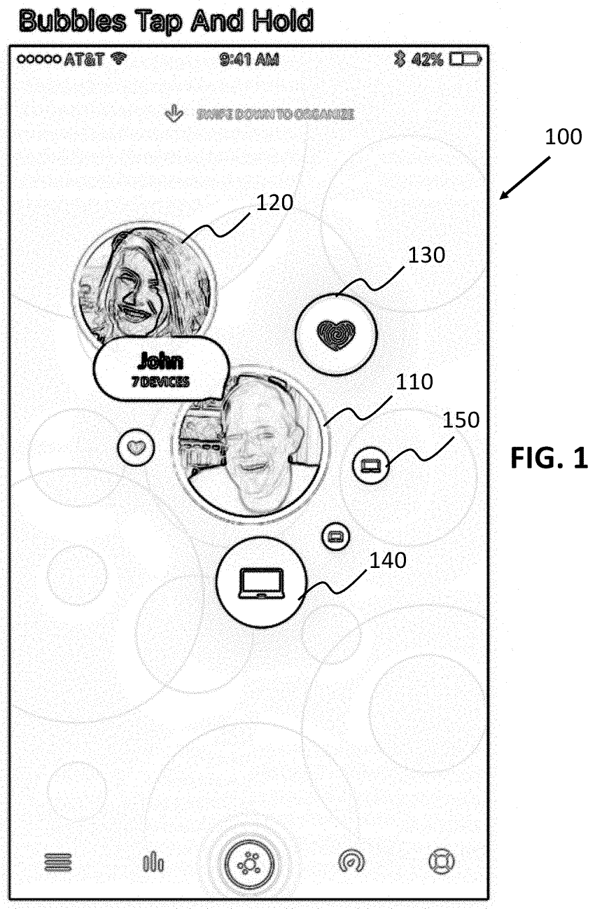

Referring now to FIG. 1, a display 100 from a mobile phone is depicted running a network impact visualizer application. The network impact visualizer application includes a graphical user interface in which a number of circles represent either groups of devices on the network such as people having a group of devices 110 and 120 or a favorites group of devices 130. Also, individual devices are represented with their own circle on the network 140 or 150. The devices on the network may be any of a variety of devices including but not limited to desktop computers, notebook computers tablets, mobile phones, appliances, monitoring equipment, wearables, etc. Each circle represents how much relative impact that device or group of devices is having on the network, this could be any of a variety of measures including how much bandwidth is being used, how much data is being transferred and at what rate, upload versus downloading of data, streaming demands, number of connections, packets per second, frames per second or any combination of these or other measures.

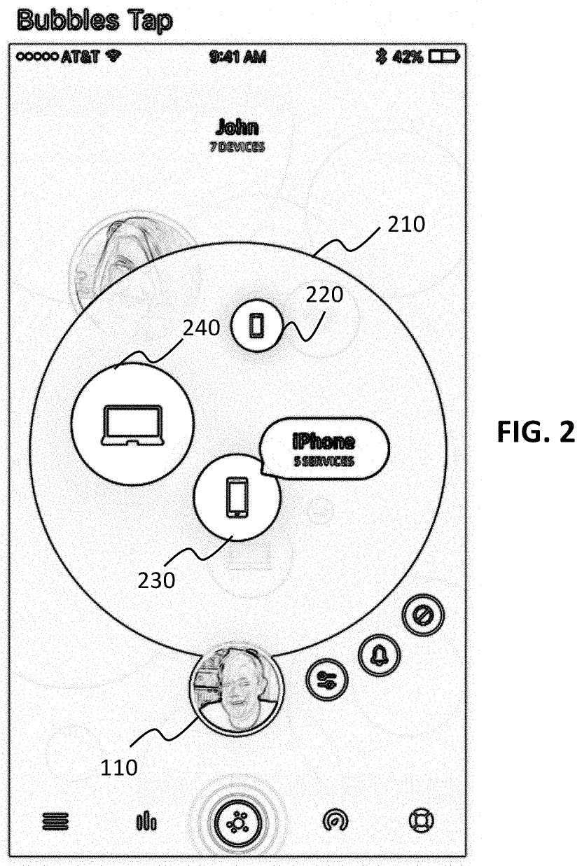

In accordance with the exemplary embodiment shown, if a user taps and holds on a group circle for example group circle 110, owned by “John” may show how many devices belong to that group. Referring now to FIG. 2, if a user taps their finger on circle 110, a larger circle 210 emerges to show the devices in that group and their relative impact on the overall network. In the example depicted in FIG. 2, John has two mobile phones 220 and 230 and a laptop computer 240. Within circle 210 if the user taps and holds the phone circle 230, it is displayed that it is an iPhone running 5 services that are using the network. The 5 services running may be any of a variety of services including but not limited to streaming services, communications services, any applications that require use of the network, etc.

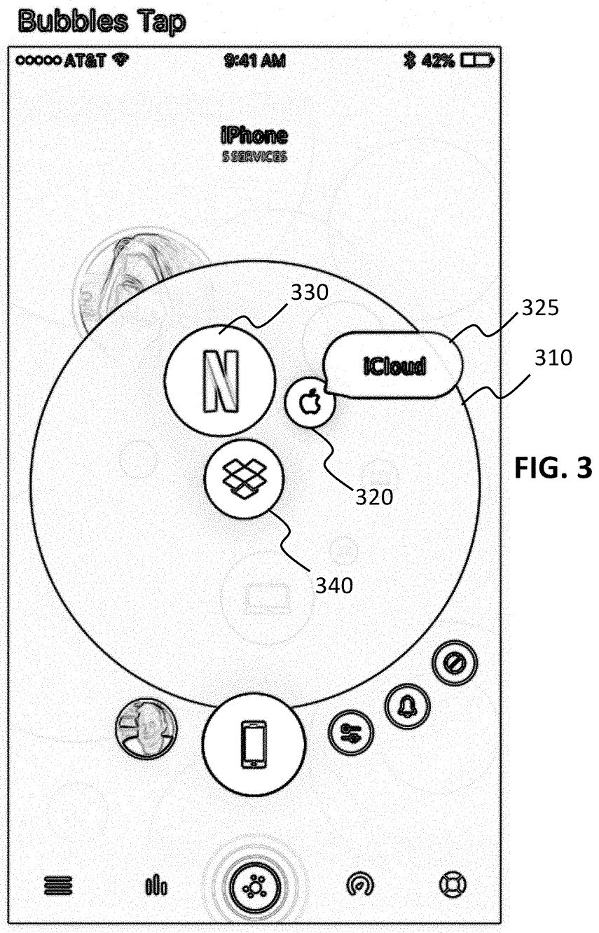

As an example, referring to FIG. 3, if the user taps the iPhone bubble 230 of FIG. 2, a circle 310, depicted in FIG. 3, emerges to display some or all of the services that are causing demand on the network. The services are represented by circles 320, 330, and 340 which also include an icon representative of the app or service running. In some exemplary embodiments it may be seen that certain services may not show up in a device circle 310 because they have so little impact on the network, or their use on the network may be private and thus not viewable by others. In the example of FIG. 3, a user may tap and hold on a circle, such as circle 320 and the name of the service or application running is displayed, for example “iCloud” 325. Each of the circles 320, 330, 340 are scaled to show the relative impact that they are having on the overall network. In alternative embodiments, it may be that in the device view the circles displayed are scaled to represent overall impact within that device.

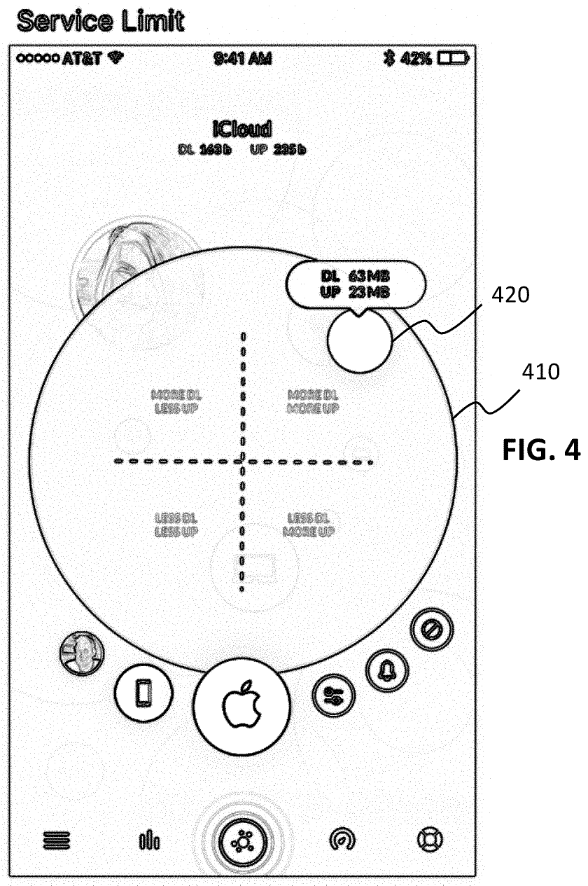

If now, a user taps the “Apple” circle 320, a Service Limit circle 410, depicted in FIG. 4, emerges. Some ISPs have limits on download data and upload data during a certain time period, for example each month. The data limits on uploads and downloads may be hard limits or may be limits after which the subscriber pays for each further amount of data used over the limit (e.g. a user may pay $10 for each 1 GB of memory used over the limit). In other ways an ISP may throttle data after a certain limit is reached in which the data may be uploaded and downloaded but at a slowed rate (e.g. a user may subscribe to a service providing 25 GB/month at 100 GB/s and after the 25 GB limit is reached the ISP slows service to 1 GB/s). Service Limit circle 410 depicts how much upload and download service is available and circle 420 represents the amount that is being used by the current upload and downloads (e.g. the Download is 63 Mb and the Upload is 23 Mb). By having this data readily and simply represented in a user friendly graphical manner provides greater usability to each and everyone who utilizes data services on the network.

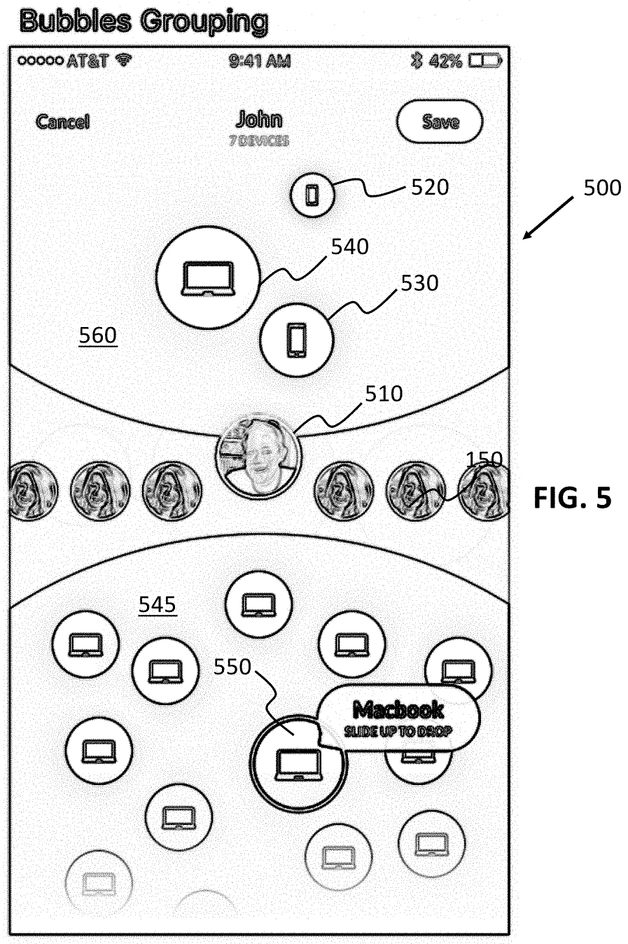

Referring now to FIG. 5, a group set up screen 500 is depicted. Group set up screen 500 is used to associate various devices with their owners or alternatively put them in other associated groups (e.g., a user could form a group called “Security” and place all the security devices that are connected to the network in that group such as cameras, locks, and alarms, etc.). FIG. 5 depicts the setting up of the “John” group which has an icon 510, which may selectively be a picture of John or any other picture or icon. John's group currently includes the devices 520, 530, and 540. The circles in area 545 include other devices on the network which may be selectively associated with John. For example, if a user taps on and holds a circle, such as circle 550, which is desired to be associated with John, the user then slides the circle up and drops it in area 560. Once all of the devices to be associated with John are in the area 560, the user taps the “Save” button 570 to save the associations.

The functionality described above may be used on any of a variety of devices, such as but not limited to mobile phones, tablets, notebook computers, desktop computers, connected watches, TVs, appliances, and other devices having a display and input interface. Further, the functionality described enables users to quickly and easily assess whether a sluggish network is being caused by devices heavily impacting the network, as well if there are certain devices dominating the network resources. If certain devices are dominating network resources, the application described above allows a user to easily and quickly identify which of those devices is dominating network resources. Being able to identify that a local network is being burdened by devices overloading network resources can prevent many unnecessary customer service calls to the ISP who has no control of the devices on the network.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently.

Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A non-transient computer readable medium having program code stored thereon for causing a processing device to perform the method comprising:
accessing information related to local area network traffic, by the processing device;
receiving the information;
displaying a graphical user interface (GUI) for a user of the network;
calculating a percentage of impact for each device connected to the network that is using resources on the network; and
displaying by the GUI, geometric shapes whose areas on the GUI approximate the relative impact that each device or group of devices has on the network.

2. The non-transient computer readable medium of claim 1, wherein the geometric shapes include polygons.

3. The non-transient computer readable medium of claim 1, wherein the geometric shapes include ellipses.

4. The non-transient computer readable medium of claim 1, wherein each geometric shape represents a single device.

5. The non-transient computer readable medium of claim 1, wherein each geometric device represents a group of devices.

6. The non-transient computer readable medium of claim 1, wherein each geometric device represents a group of devices having a single owner.

7. The non-transient computer readable medium of claim 1, wherein some geometric shapes represent groups of devices associated with a single user.

8. The non-transient computer readable medium of claim 1, further comprising:
providing an action on a geometric shape on the GUI that causes a group of devices to be expanded and display at least some of the devices within that group and their relative impact on the network.

9. The non-transient computer readable medium of claim 1, further comprising:
providing an action on a geometric shape on the GUI that causes a display on the GUI to indicate how many devices are associated with a particular group.

10. The non-transient computer readable medium of claim 1, further comprising:
providing an action on a geometric shape on the GUI that causes a display of services running on a particular device and each services' relative impact on the network.

11. The non-transient computer readable medium of claim 1, further comprising:
providing an action on a geometric shape on the GUI that enables the ability to create the groups of devices.

12. The non-transient computer readable medium of claim 1, wherein the program code is an app and the processing device is a mobile electronic device.

13. A Wi-Fi network, comprising:
a wireless router;
a plurality of devices wirelessly communicating with the wireless router;
at least one of the plurality of devices running a network analyzer or the network analyzer running on a cloud server, the network analyzer comprising program code for carrying out the steps of:
accessing information related to local area network traffic from the router, by the network analyzer;
receiving the information by the network analyzer;
displaying a graphical user interface (GUI) on the at least one of the plurality of devices;
calculating a percentage of impact for each device connected to the Wi-Fi network that is using resources on the Wi-Fi network; and
displaying by the GUI geometric shapes whose areas on the GUI approximate the relative impact that each device or group of devices has on the Wi-Fi network.

14. The Wi-Fi network of claim 13, wherein some geometric shapes represent groups of devices associated with a single user.

15. The Wi-Fi network of claim 13, further comprising:
providing an action on a geometric shape on the GUI that causes a group of devices to be expanded and display at least some of the devices within that group and their relative impact on the Wi-Fi network.

16. The Wi-Fi network of claim 13, further comprising:
providing an action on a geometric shape on the GUI that causes a display on the GUI to indicate how many devices are associated with a particular group.

17. The Wi-Fi network of claim 13, further comprising:
providing an action on a geometric shape on the GUI that causes a display of services running on a particular device and each services' relative impact on the Wi-Fi network.

18. The Wi-Fi network of claim 13, further comprising:
providing an action on a geometric shape on the GUI that enables the ability to create the groups of devices.

19. The Wi-Fi network of claim 13, wherein the network analyzer is an app and the processing device is a mobile phone.

20. A communications network, comprising:
a router;
a plurality of devices wirelessly communicating with the router;
at least one of the plurality of devices running a network analyzer or the network analyzer being run on a cloud server, the network analyzer comprising:
a means for accessing information related to local area network traffic from the router, by the network analyzer;
a means for receiving the information by the network analyzer;
a means for displaying a graphical user interface (GUI) on the at least one of the plurality of devices;
a means for calculating a percentage of impact for each device connected to the communications network that is using resources on the communications network; and
a means for displaying by the GUI, geometric shapes whose areas on the GUI approximate the relative impact that each device or group of devices has on the communications network.
